(19) United States
(12) Patent Application Publication
(10) Pub. No.: US 2007/0056096 A1
(43) Pub. Date: Mar. 15, 2007

(54) Bed pad with polyethylene layer

(75) Inventor: Kenneth Assink, Holland, MI (US)

Correspondence Address: FAY SHARPE LLP, 1100 SUPERIOR AVENUE, SEVENTH FLOOR, CLEVELAND, OH, 44114, US

(73) Assignee: Illinois Tool Works Inc.

(21) Appl. No.: 11/503,789

(22) Filed: Aug. 14, 2006

Related U.S. Application Data
(60) Provisional application No. 60/716,399, filed on Sep. 13, 2005.

(51) Int. Cl. A61G 7/10

(52) U.S. Cl. 5/81.1 HS; 5/626

(57) ABSTRACT

A bed pad is described comprising a padding layer and at least one sheet layer adjacent to the padding layer. The sheet layer is formed from a web of very fine polyethylene fibers. The padding layer provides support for the patient. The sheet layer comprises a fabric material that is comfortable for the patient to use. The bed pad provides a means for either adjusting a patient within a bed or for transferring a patient from one bed to another bed or medical table. The bed pad may also be used as part of a stretcher or separately as a bedroll. The bed pad may optionally contain gripping components and drapes.

### CROSS REFERENCES TO RELATED APPLICATIONS

This application claims priority from U.S. provisional application Ser. No. 60/716,399 filed Sep. 13, 2005, which is herein incorporated by reference.

### BACKGROUND OF THE INVENTION

For a variety of reasons and situations, patients in a hospital or medical environment frequently need to be moved. A patient may need to be moved to reposition the patient within their bed, transfer the patient from one bed to another bed or medical table, or to change the patient's bedding. However, several problems may be encountered in the movement of a patient. Physically lifting the patient may require several medical staff members to lift the patient to ensure that the patient's limbs and/or extremities are not loose and subject to jostling or random motions that may cause discomfort. Even if several persons assist in the lifting of the patient, the patient may be subjected to subtle movements in direction if the persons moving the patient do not act in concert with one another. Problems are also encountered when it is necessary to either adjust the patient's position in the bed or transfer them to another bed. The patient is potentially subjected to numerous movements, each with the potential for increasing the discomfort of the patient, or as may be the case with elderly patients, inflicting additional harm.

Similarly, military personnel may use a stretcher consisting of two rigid poles and a flexible fabric material stretched between the poles in order to transport a soldier from the field to receive medical aid. Such a flexible material should be strong enough to bear the weight of a soldier who may be placed in it. It should also be tear-resistant and waterproof in order to prolong its operational life. However, current fabrics used in military stretchers often fail when subjected to loads of about 200 pounds, particularly if the fabric degrades or ages.

Soldiers, as well as recreational users, also carry bedrolls with them that provide a light, portable, comfortable place for them to sleep and protect them from the varying ground conditions in which they find themselves. Although satisfactory in many respects, it is desirable to provide an improved lighter and/or more useful bedroll.

Accordingly, it is desirable to provide a device or system that provides for an effective means of moving a patient that minimizes the discomfort encountered by the patient in any such move and aids personnel in moving the patient.

And, it is also desirable to provide a component for use in conjunction with the two rigid poles to thereby serve as a stretcher which exhibits a high load-bearing capacity.

It is also desirable to provide an improved lightweight, portable, comfortable device or system that may be used as a bedroll.

### BRIEF DESCRIPTION

In a first aspect, the present invention relates to a bed pad comprising a padding layer having an upper surface and a lower surface. The bed pad also comprises a strength-promoting layer. And, the bed pad comprises at least a first sheet layer disposed adjacent to the upper surface of the padding layer. The first sheet layer consists essentially of randomly distributed, very fine polyethylene fibers that are bonded to one another.

In another aspect, the present invention relates to a bed pad comprising a first sheet layer and a second sheet layer. The bed pad also comprises a padding layer disposed between the first sheet layer and the second sheet layer. And, the bed pad comprises a strength-promoting layer disposed adjacent to the padding layer. The first and second sheet layers each include a web of heat and pressure-bonded, 100% polyethylene fibers. The bed pad includes a collection of gripping components which may be for example reinforced openings defined in the bed pad, handles, straps, or combinations thereof.

In yet another aspect, the present invention relates to a bed pad comprising a first sheet layer, a second sheet layer, a strength-promoting layer disposed between the first sheet layer and the second sheet layer, and a padding layer disposed between the first sheet layer and the second sheet layer. Each of the first and second sheet layers exclusively comprise randomly distributed, very fine high-density polyethylene fibers that are bonded to one another. Each of the first and second sheet layers have a basis weight of from about 1 to about 3 oz/yd². The bed pad also includes a collection of gripping components.

### BRIEF DESCRIPTION OF THE DRAWINGS

The following detailed description may be more readily understood when read in reference to the accompanying drawings:

FIG. 1a is a perspective view of a first embodiment of a bed pad according to the present invention.

FIG. 1b is a side view of the bed pad in FIG. 1a.

FIG. 2 is a side view of a second embodiment of a bed pad according to the present invention.

FIG. 3 is a perspective view of a third embodiment of a bed pad according to the present invention.

FIG. 4a is a perspective view of a fourth embodiment of a bed pad according to the present invention.

FIG. 4b is a perspective view of a fifth embodiment of a bed pad according to the present invention.

FIG. 5 is a perspective view of a sixth embodiment of a bed pad according to the present invention.

FIG. 6 is a perspective view of a seventh embodiment of a bed pad according to the present invention.

FIG. 7 is a perspective view of an eighth embodiment of a bed pad with drapes according to the present invention.

FIG. 8 is a perspective view of a ninth embodiment of a bed pad according to the present invention.

FIG. 9a is a top planar view of a bed pad with hinge providing tabs according to the present invention.

FIG. 9b is a top planar view of another bed pad with tabs according to the present invention.

FIG. 10 is a perspective view of two bed pads which have been attached to each other using tabs provided on each bed pad.

### DETAILED DESCRIPTION OF THE PREFERRED EMBODIMENTS

A bed pad is provided that comprises at least two layers and is capable of being used as an aid for the easy adjustment of patients within a bed and/or the easy transfer of a patient from one bed to another bed or medical table. It can also be used as the flexible fabric material between the two poles of a stretcher or, carried separately, as a bedroll. The present invention bed pad can serve multiple applications. A bed pad according to the present invention comprises a padding layer and at least one sheet layer adjacent to the padding layer. The padding layer is comprised of a pad or mat and provides support for the bed pad of the invention. The sheet layer is a layer adjacent to the padding layer, and provides the surface upon which the patient lies. Other layers may be included depending upon the end use application.

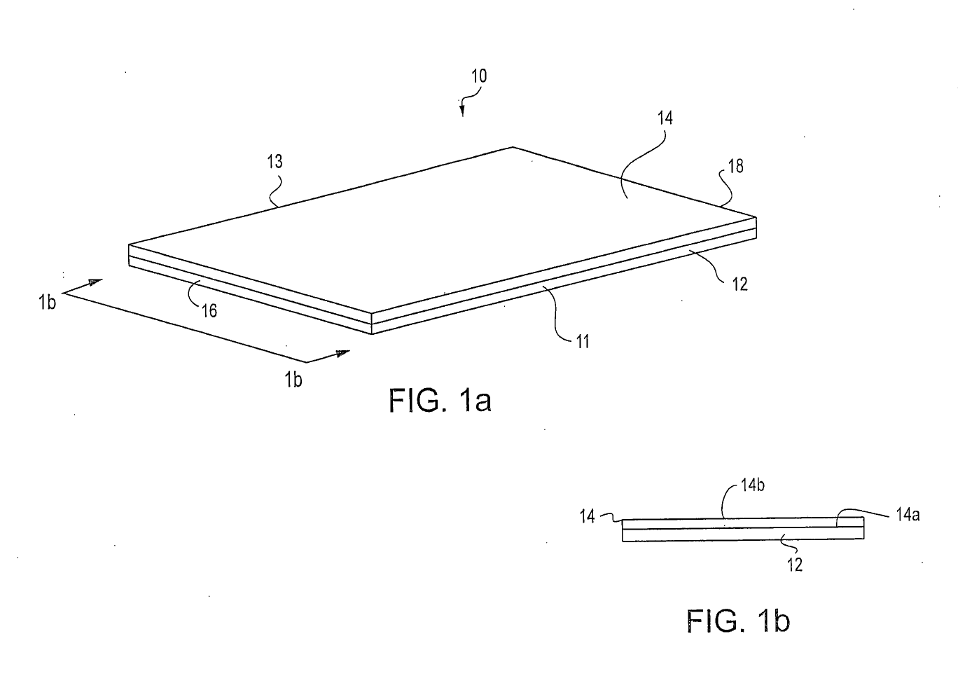

In a first configuration, such as the embodiment shown in FIG. 1a and 1b, a bed pad 10 according to the invention is a two-layer or laminate construction comprising a padding layer 12 and a sheet layer 14 adjacent to the padding layer. The sheet layer comprises two surfaces or faces, one surface 14a which is in contact with a surface of the padding layer, and an exposed surface 14b. The exposed surface provides the outer surface of the bed pad and is generally the surface upon which the person lies. Alternatively, in this configuration, a person could be placed on the exposed surface of the padding layer, i.e., the surface which is not in direct contact with a surface of the sheet layer. However, due to the materials from which the respective layers are made (discussed further herein), the person usually lies or is placed upon the sheet layer. The bed pad has two sides, 11 and 13, which are preferably straight and extend parallel to each other along the length of the bed pad. The bed pad 10 also has two ends, 16 and 18, which extend along the width of the bed pad. While the two ends are depicted here as straight and parallel to each other, they may have independently different lengths and shapes. For example, the ends may be in the form of a curve such as a half-circle. In one variant embodiment, the bed pad might have the shape of a rectangle with two half-circles at each end.

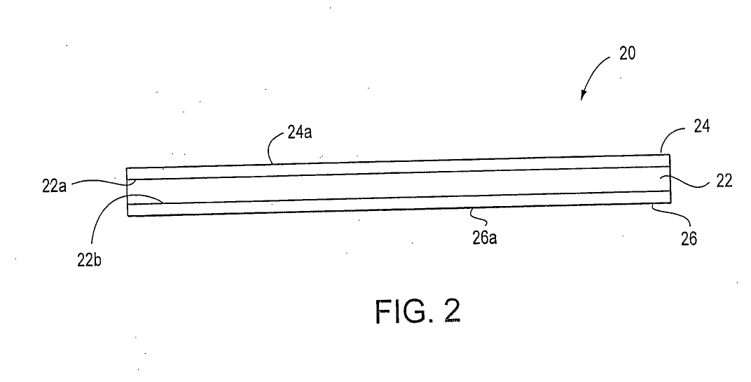

FIG. 2 depicts a second embodiment of a bed pad according to the present invention. The bed pad 20 is a three-layer laminate or sandwich construction comprising a padding layer 22 having a first surface 22a and a second surface 22b, a first sheet layer 24 adjacent to one of the surfaces of the padding layer, and a second sheet layer 26 adjacent to the other surface of the padding layer. The two sheet layers provide a bed pad having two exposed sheet surfaces, e.g. 24a and 26a, upon which the person may lie. In the bed pad depicted in FIG. 2, the sheet layers have the same dimensions as the padding layer and thus the periphery or sides of the padding layers are exposed. Optionally, the sheet layers may have dimensions such that a portion of the ends and sides of the sheet layers extend beyond the ends and sides of the padding layer. The excess portions of the sheet layers may then be attached to one another, thereby fully enclosing the padding layer. The side of the bed pad contacting the bed, which may be the padding layer in the two-layer construction of FIG. 1 or one of the sheet layers in the three-layer construction of FIG. 2, may have a low coefficient of friction to facilitate easy sliding of the bed pad.

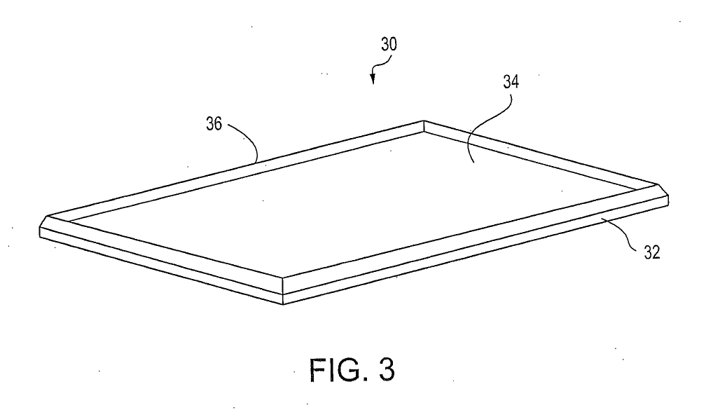

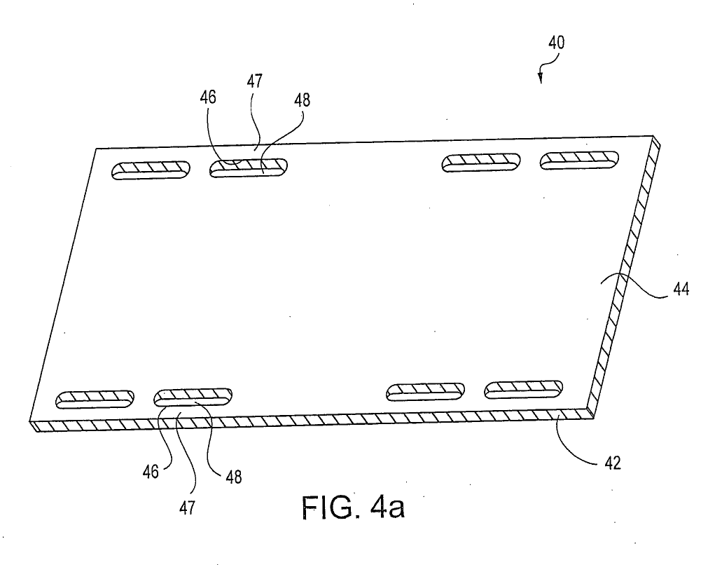

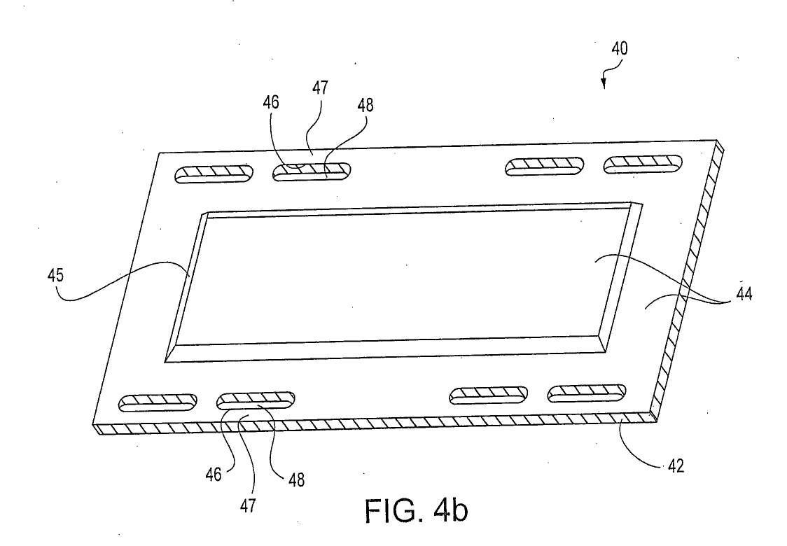

Additionally, a bed pad may utilize a border extending from the top surface of the bed pad, i.e., extending from the exposed surface of the sheet layer. The embodiments depicted in FIGS. 3 and 4b include such a border. In FIG. 3, the bed pad 30 comprises a padding layer 32 and a sheet layer 34 adjacent thereto (similar to the bed pad depicted in FIGS. 1a and 1b). The bed pad 30 further comprises a border 36 adjacent to the top surface of the top layer and extending around the periphery of the sheet layer. FIG. 4b depicts another embodiment that includes a border. In FIG. 4b, the bed pad 40 has a padding layer 42, a sheet layer 44 adjacent to the padding layer, and a border 45 adjacent to and extending from the surface of sheet layer 44. In the embodiment in FIG. 4b, the border 45 does not extend around the periphery of the bed pad 40 as does the border 36 in the embodiment in FIG. 3. Rather, in FIG. 4b, the border is contained within the top surface of the bed pad 40 such that portions of the sheet layer are exposed on the sides and ends of the bed pad between the border and edges or periphery of the bed pad. A border has a height of about 0.25 inches and a width of from about 0.5 inches to about 1.5 inches for example. In one embodiment, the border is a foam material. In another embodiment, the foam material of the border is adapted to collect and retain liquids within the pad. In place of foam, other liquid absorbent materials may be used. The border may be attached to the sheet layer by any suitable means including, but not limited to, the use of adhesive, stitching, sewing, stapling, and thermal bonding techniques. The border may be used to prevent any fluids from running off of the bed pad. While FIGS. 3 and 4 depict the use of a border in conjunction with a two-layer bed pad construction, the present invention also contemplates the use of a border in conjunction with a three or more layer or sandwich construction. When used with a three-layer construction, a border is usually attached to only one of the sheet layers.

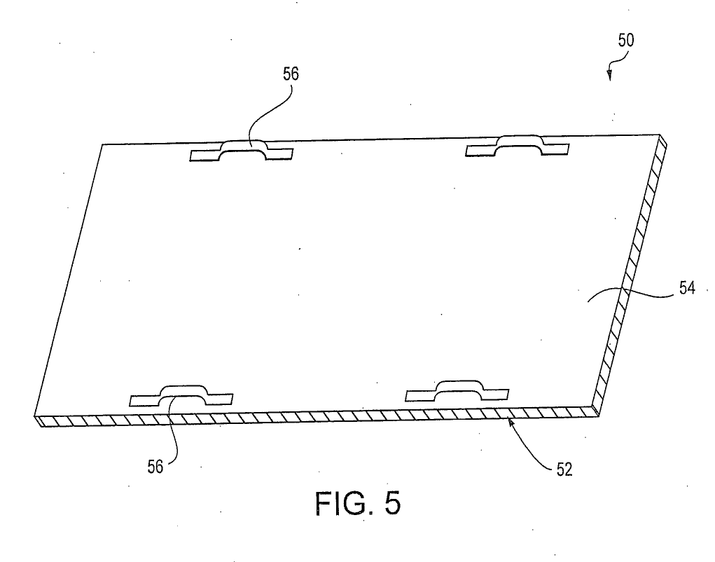

A bed pad may also include a plurality of components for gripping, grasping, or taking hold of the bed pad to facilitate moving the bed pad (and the person lying thereon). Any suitable means for gripping or taking hold of the bed pad may be included, including but not limited to holes or openings in the bed pad and/or handles. Embodiments of bed pads that include a gripping means or components are depicted in FIGS. 4a, 4b, and 5. The embodiments in FIGS. 4a and 4b show a bed pad 40 having padding layer 42 and sheet layer 44 adjacent to padding layer 42. The bed pad 40 further includes a plurality of holes or openings 48. The openings are preferably longitudinal slots 46 that are formed by portions of the bed pad which have been removed. A person may insert their hands or fingers through the openings to grasp the pad. Specifically, the slots essentially create a handle 47 on the surface of the pad in the region between the opening 48 and the edge of the pad. The holes or openings that provide a means to grasp or hold a bed pad may have any desired shape or size and are not limited to the longitudinal slots depicted in FIGS. 4a and 4b. Additionally, the number of holes or openings may be chosen based on the size of the pad and/or the end user's needs.

In FIG. 5, bed pad 50 has a padding layer 52 and sheet layer 54 adjacent thereto. The pad 50 further includes a plurality of handles 56 as gripping means. As depicted in FIG. 5, the handles are strap handles made from a flexible and/or manipulable material. The straps may be formed from any flexible material that is sufficiently strong enough such that the strap will not break during lifting. Non-limiting examples of suitable materials for a strap include nylon or nylon products (e.g., woven nylon materials). In the case of a strap handle, the handle is created by attaching the ends of the material to the bed pad, such that a portion of the strap between the ends of the straps (that have been attached to the bed pad) is not attached to the bed pad. The unattached portion of the strap, when manipulated, provides a space between the surface of the bed pad and the underside of the strap through which a person may insert their fingers to take hold of the strap. Retention straps may also be used as the handle. Alternatively, the handles may be made from more rigid materials, including but not limited to plastics, metals or the like. The handles may be permanently attached to or detachable from the bed pad. Where a handle is made from a rigid material, it may be desirable to place some type of soft padding material around the handle. The use of such material would provide comfort to personnel handling the pad and also protect persons lying on the pad from the hard, rigid handles. As with the use of holes or openings for the means to grasp the pad, there is no limit with respect to the size, shape, or quantity of handles used on a bed pad. Further, the location of the plurality means to grasp the bed is not limited in any manner. Additionally, combinations of gripping means may be provided on the pad; e.g., a pad may provide both openings in the pad as gripping means for hands and nylon straps through which poles may be run to turn the bed pad into a stretcher. Preferably the gripping means are located to provide for sufficient, uniform support of the person when the pad is lifted or moved.

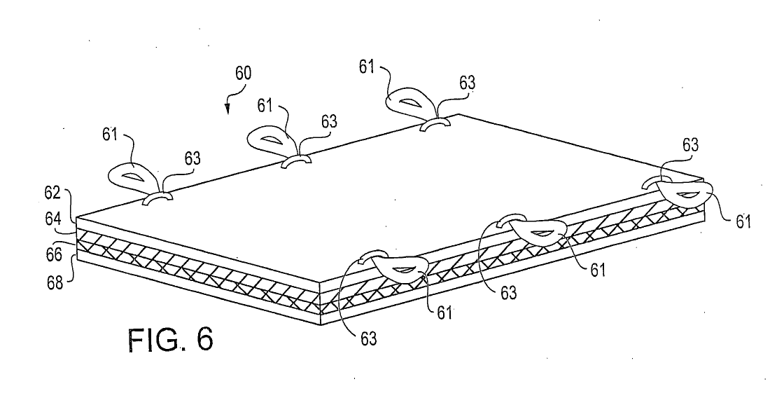

In FIG. 6, the bed pad 60 is a four-layer laminate or sandwich construction comprising a padding layer 64 adjacent to a strength-promoting layer 66. Adjacent to the padding layer 64 is a first sheet layer 62 and adjacent to the strength-promoting layer 66 is a second sheet layer 68. A number of straps 61 which are fastened to the bed pad 60 by fastening means 63 are provided along opposite sides running the length of the bed pad 60. In this embodiment, two poles may be run through the straps to form a stretcher. Although FIG. 6 is depicted as having six straps, there is no limit with respect to the size, shape, quantity, or the location of straps used on the bed pad.

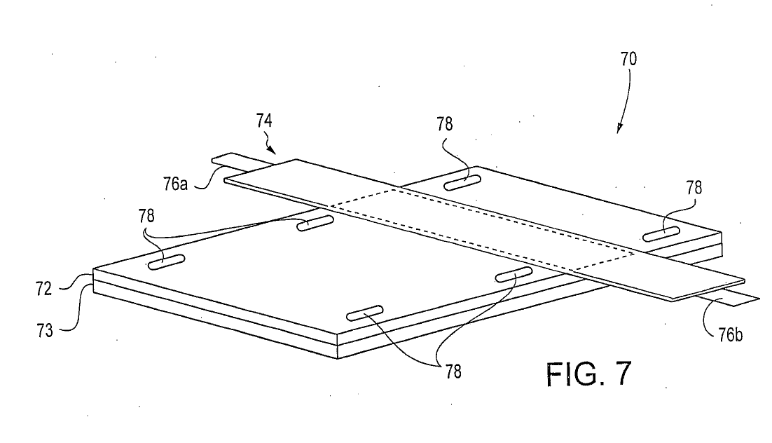

FIG. 7 illustrates a bed pad 70 with drapes. The drapes can serve to hold or otherwise retain a person's arms within the dimensions of the bed pad to prevent them from being injured and/or impeding personnel who are moving the bed pad. In FIG. 7, the bed pad 70 is a two-layer construction comprising a padding layer 73 and a sheet layer 72. Gripping means 78 are provided preferably along two or more sides or regions of the pad 70. Drapes 74 are integrally attached to the sheet layer 72. The drapes 74 are shown with optional complementary fasteners 76a and 76b. For example, in FIG. 7, 76a is the hook portion of a Velcro strap and 76b is the loop portion of a Velcro strap. Other fasteners may be used, e.g. zippers, a clasp and slot, button and buttonhole, etc. One or more drapes may be utilized in conjunction with the bed pad. For example, a single drape may be utilized which is attached to and extends from one side or region of the bed pad. Alternately, two or more drapes may be used. The drapes can be either releasably or permanently attached to the bed pad.

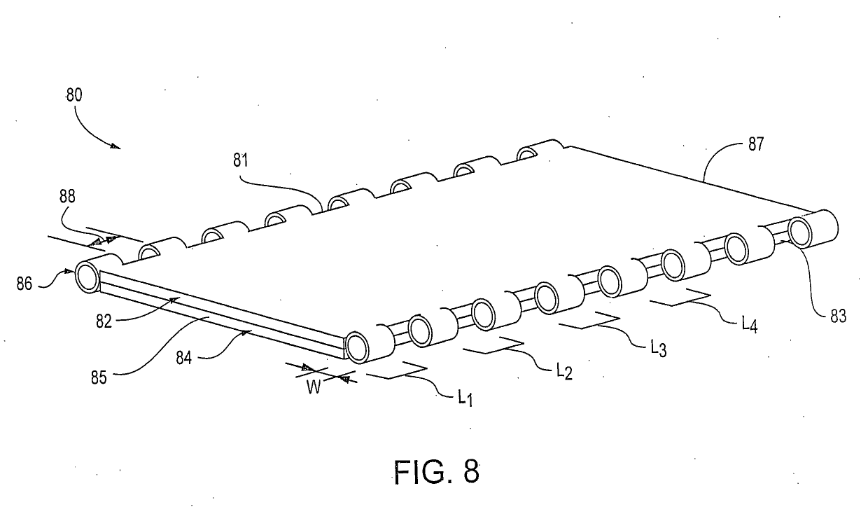

FIG. 8 illustrates a bed pad 80 with a plurality of outwardly extending tabs that can serve as hinges or as interlocking members. The bed pad includes a plurality of these tabs, each tab preferably defining an aperture adapted to receive a support member such as a pole, described in greater detail herein. The bed pad 80 is a two-layer or laminate construction comprising a padding layer 84 and a sheet layer 82, although additional layers may be utilized. Tabs are located along the sides 81 and 83. The ends 85 and 87 are shown as generally straight and extending parallel to each other; however, they may also exhibit different forms such as being arcuate or curved. A hinge 86 is created by removing part of a side or end of the bed pad 80 to create a tab and a void 88. The tab is then folded back upon itself and the outer edge of the tab is heat sealed or heat bonded to the main body of the bed pad to create a hinge of diameter W. The resulting hinge is a cylindrical opening that is an integral part of the bed pad and operates as a door hinge. Rigid poles can be inserted through these hinges, e.g. for a stretcher. Preferably, the hinge has no exposed edges which might fray and reduce the operating life of the bed pad. The tab comprising or forming each hinge is preferably cut out of both the sheet layer (or layers) and the padding layer so that the hinge is the same thickness as the rest of the bed pad. In this illustration, the outer edge of the tab is heat bonded to the padding layer; however, this is not a requirement. For example, in the case of a three-layer construction comprising a padding layer and two sheet layers, the outer edge of the tab may be heat bonded to one of the sheet layers. While depicted as having eight hinges on the sides 81 and 83 of the bed pad, there is no limit as to the number of hinges or their location. In FIG. 8, the length of a hinge is shown as L₁ and the length of a void is shown as L₂. L₁ and L₂ can vary independently, but are preferably the same length. In one embodiment, both L₁ and L₂ are about 3 inches. The diameter of each hinge W is independent with respect to L₁ and L₂. It should be noted that the length of each hinge may independently differ from the length of another hinge. For example, L₁ and L₃ are lengths of different hinges; L₁ may be 4 inches while L₃ is 3 inches. The length of each void may also independently differ from the length of another void. L₂ and L₄ may be different lengths.

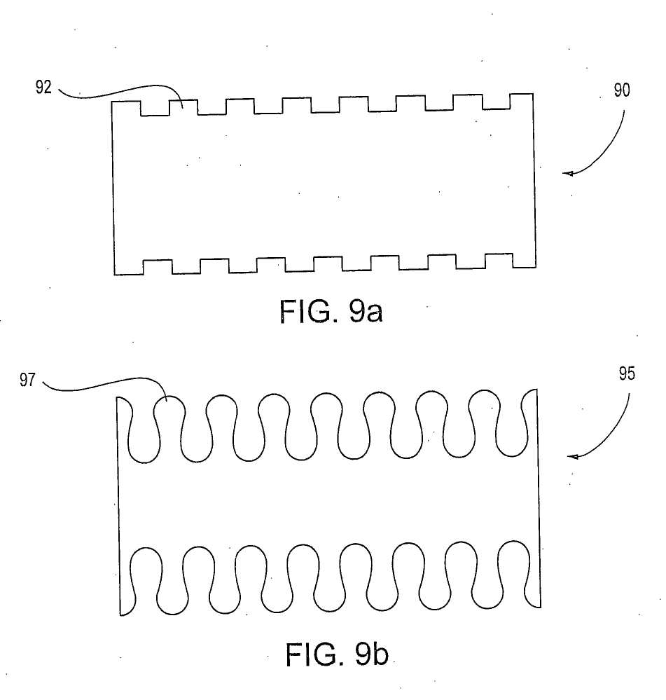

FIGS. 9a and 9b are planar top views of bed pads 90 and 95. These figures show that there is no limit as to the shape of the tabs. In FIG. 9a, the tabs 92 are square or rectangular. In FIG. 9b, the tabs 97 are arcuate or “puzzle cut”. The shape of the tab may be determined for aesthetic or practical reasons. For example, a puzzle cut tab would aid in joining two separate bed pads and holding them together without the use of an external aid (such as a rigid pole).

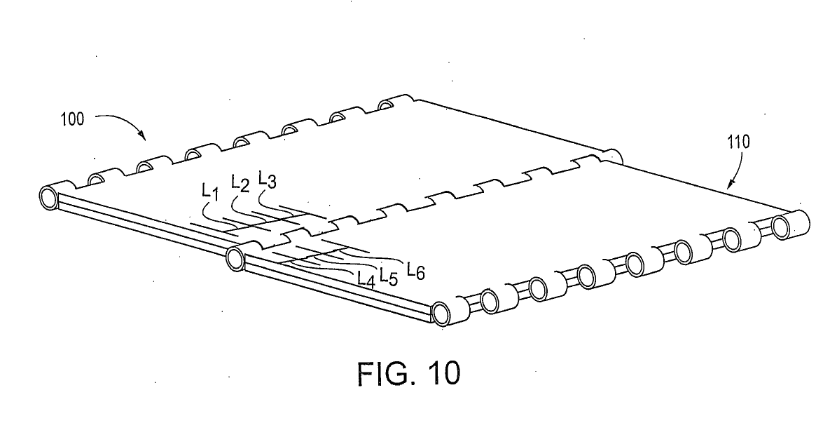

FIG. 10 is another embodiment of a bed pad assembly. Two bed pads 100 and 110, not necessarily identical to each other, are shown positioned in the same plane relative to each other. They are offset from each other by the length of one tab and laid together with the tabs of one pad fitting into the voids of the other pad. When positioned in this fashion, the two pads may be further connected and secured together by inserting a rigid pole through the tabs though this is not required. Each bed pad 100 and 110 is generally shown in FIG. 8, though the lengths and widths of each bed pad and their tabs and voids may vary independently. Although the two bed pads are depicted as laid side-by-side, this is not required. In one embodiment, bed pad 100 has tabs along its sides and bed pad 110 has tabs along its ends. They may still be laid next to each other with the tabs of each pad fitting into the voids of the other pad. The tabs do not need to fit tightly into the voids of the other pad. In this illustration, L₁ and L₃ are the lengths of two tabs on bed pad 100 and L₂ is the length of the void between them. Similarly, L₄ and L₆ are the lengths of two hinges on bed pad 110 and L₅ is the length of the void between them. When L₁=L₂=L₃=L₄=L₅=L₆, the tab of length L₁ fits into the void of length L₅ and the tab of length L₆ fits into the void of length L₂. However, in another embodiment where L₁=L₃=L₄=L₆ and L₂=L₅ and L₁<L₂, the tabs would still fit within the void, but would have some “play” where they could move back and forth within the void. For example, in one embodiment where L₁=L₃=L₄=L₆=2 inches and L₂=L₅=4 inches, there would be 2 inches of movement between the two bed pads.

The dimensions of a bed pad according to the invention may vary according to the needs of the end user or the particular application. The dimensions of the bed pad may, in certain applications, generally conform to the dimensions of beds utilized in a hospital, nursing home, or other medical or patient care environment. The bed pad may also conform to the dimensions of stretchers or gurneys. In one embodiment, the bed pad has a length such that the person's entire body is capable of making contact with the pad. That is, no part of the person extends beyond or hangs off of the edges of the bed pad. In another embodiment, the bed pad has a width of from about 16 inches to about 45 inches and a length of from about 45 inches to about 84 inches. The size of the pad may also vary depending upon the use. Emergency usage pads will generally be smaller, having a width of about 24 inches and a length of about 60 inches. A large pad may also be folded to conform to smaller dimensions, i.e. folding a pad in half. The foregoing dimensions are merely exemplary and are not intended to limit the scope of the concept in any way. It is contemplated that a bed pad may have larger or smaller dimensions as desired and/or needed by an end user.

A bed pad has a thickness of from about 0.125 inches to about 2 inches. In embodiments for use in a hospital, the pad may be made as thin as possible for the person to lie on. In this embodiment, the bed pad preferably has a thickness of from about 0.125 inches to about 0.375 inches and most preferably from about 0.125 inches to about 0.188 inches. The pad, however, must have a thickness sufficient to support the person during the transfer or movement of a person. In embodiments for use as a bedroll, the pad may be thicker in order to cushion the user from ground conditions such as rocks and small holes to provide greater comfort when used. In this embodiment, the bed pad preferably has a thickness of from about 1 inches to about 2 inches.

It may be desirable to include a system or sensor to monitor and/or detect when fluids are gathering or otherwise collect on the bed pad. A bed pad may include one or more sensors disposed between the sheet layer and the padding layer. In an embodiment where the sheet layer is fluid-repellant and/or impervious to the flow of fluids, sensors may be placed on the top surface of the sheet layer. Sensors may be placed at any location and are preferably located in regions likely to receive moisture. For example, in a hospital environment it is advantageous to utilize sensors in regions of the bed pad that would be expected to receive moisture from the discharge of urine or other electrolytic bodily fluids. Sensors preferably have a minimal thickness such that the flexibility and comfort of the bed pad are not compromised. Any suitable moisture detector or sensor may be used as the sensor, including but not limited to the moisture monitoring systems disclosed in U.S. Pat. Nos. 6,292,102 and/or 6,580,013, both of which are incorporated herein by reference. Employing a moisture sensor/detector system in a bed pad provides several advantages. The use of moisture sensors or detectors provides a means to notify hospital or nursing home personnel when a patient needs assistance. Sensors notify patient care personnel when a patient's bedding needs to be changed or cleaned, when a bed pad needs to be cleaned, and/or when a patient needs further care or assistance. Such systems also allow medical or patient care personnel to monitor a patient's condition (for example, whether an incontinent patient's condition is improving or not). The use of moisture detectors further allows medical personnel to record a patient's fluid activity. Recording such activity is useful to monitor the patient's condition (such as the time intervals between such activity) and to monitor the time it takes for patient care personnel to respond and provide the appropriate assistance to the patient. Thus, the use of moisture sensors in conjunction with the bed pad is advantageous and provides better patient care.

Alternatively, it may also be desirable to include a system or sensor to monitor and/or detect pressure levels exerted on the patient. Bedsores are caused by constant pressure to the skin and muscle and/or by shearing forces and can develop in a matter of hours; prevention of this injury is highly desirable, especially in immobile patients. One or more sensors may be disposed between the sheet layer and the padding layer of the bed pad. Sensors may be placed at any location and are preferably located in regions where high pressures are likely, e.g. bony protrusions like the shoulders and buttocks. Sensors preferably have a minimal thickness such that the flexibility and comfort of the bed pad are not compromised. Any suitable pressure detector or sensor may be used as the sensor, including but not limited to the pressure monitoring system disclosed in U.S. Pat. No. 6,134,970, which is incorporated herein by reference. The use of pressure sensors may notify medical personnel of the need to move a patient so that high pressure is not applied to the same portions of the body for long periods of time. Thus, the use of pressure sensors in conjunction with the bed pad is advantageous and provides better patient care.

Any suitable material may be used as the padding layer. The material should be soft and pliable enough to provide the person with a comfortable surface upon which to lie, but rigid enough such that it will adequately support the person's weight when the pad is used to move the person. Additionally, it is preferable that the material used in the padding layer is a breathable material. A non-limiting example of a material suitable for use as the padding is a 10-oz needled mat of polyethylene terephthalate (PET) thermobond fiber. Another suitable composition includes a fiber composition comprising from about 10% to about 25% of rayon, from about 30% to about 40% PET, and from about 30% to about 40% of a PET bi-component. The PET bi-component is a polymer containing PET and a polyolefin. Any polyolefin may be used in the PET bi-component, including but not limited to olefins having 2-30 carbon atoms. Particularly suitable (poly)olefins include polyolefins of ethylene, propylene, butene, pentene, hexene, heptene, octene, nonene, decene, undecene, and dodecene. A particularly preferred polyolefin is polyethylene. Another suitable composition used to form the padding layer is a fiber composition comprising from about 60% to about 80% PET and from about 20% to about 40% Rayon. Additionally, cotton may be added to the fiber compositions in minor amounts to make the pad softer if desired. Cotton may be added in amounts of up to about 25% of the composition. In forming the padding layer, it is desirable to needle or entangle the fibers in order to increase the strength of the padding layer. It is also preferable that the padding layer exhibit antibacterial properties. The padding layer may be treated with an antibacterial component after the pad is formed. Preferably, an antibacterial agent or material is included in the fiber composition. An antibacterial component may be added to the fiber composition in from about 10% to about 15% by weight of the fiber composition. Any suitable antibacterial agent or material known or used in the art may be used in the padding layer. The padding layer may be water-repellant or water-absorbent depending on the end user's needs. In the case of a two-layer construction, it may also be desirable for the padding layer to have a low coefficient of friction to facilitate easy sliding of the bed pad. Alternatively, it may be desirable for the padding layer to have a high coefficient of friction to prevent the bed pad from sliding around during normal movement. In one embodiment, the bed pad would be a two-layer construction with a high-friction padding layer and handles; the friction would prevent the bed pad from sliding while the handles would allow person transfer by easy lifting of the person (rather than sliding). The padding layer may obtain the water-repellant or water-absorbent properties and the low-friction or high-friction properties through the properties of the composition comprising the padding layer. Alternatively, coatings could be applied to the padding layer to impart the desired properties.

The strength-promoting layer is optional and included when it is desirable to ensure high strength in the bed pad. For example, the flexible fabric material of military stretchers has low load-bearing strength and rips or tears at loads of around 200 lbs. With a strength-promoting layer, a bed pad should be able to support loads of up to 700 lbs. The strength-promoting layer is preferably made of a breathable material. One suitable fiber composition comprises from about 10% to about 25% of rayon, from about 30% to about 40% PET, and from about 30% to about 40% of a PET bi-component. The PET bi-component is a polymer containing PET and a polyolefin. In forming the strength-promoting layer, it is desirable to needle or entangle the fibers in order to increase its strength. An antibacterial component may be added to the fiber composition in from about 10% to about 15% by weight of the fiber composition. Any suitable antibacterial agent or material known or used in the art may be used in the strength-promoting layer. The strength-promoting layer may also be water-repellant or water-absorbent depending on the end user's needs.

The sheet layer is preferably made of a fabric material. The fabric material is a breathable sheet. In one embodiment, the fabric is treated with a substance that renders the fabric repellant to fluids such as water, alcohol, blood and the like, so that fluids cannot flow through the sheet layer (and subsequently into the padding layer). In another embodiment, it is preferred that the sheet layer is capable of absorbing liquids or fluids. In the case of a three-layer construction, it may be desirable for the sheet layer to have a low coefficient of friction to facilitate easy sliding of the bed pad. Alternatively, it may be desirable to have a high coefficient of friction to prevent the bed pad from sliding around during normal movement. The sheet layer may obtain the water-repellant or water-absorbent properties and the low-friction or high-friction properties through the properties of the composition comprising the sheet layer. Alternatively, coatings could be applied to the sheet layer to impart the desired properties. Because the person lies on the sheet layer, the sheet layer should contain few chemicals and more preferably is hypoallergenic. It is also desirable that the fabric is capable of being sterilized by any method known in the art. Because, as discussed further herein, a bed pad in accordance with the present development may be used in place of traditional hospital beddings, it is highly desirable that the fabric material provide a suitable surface upon which a person may lie. That is, it is desirable for the fabric to provide softness and comfort comparable to traditional beddings, with the attendant advantage of being fluid repellant or absorbent and capable of being sterilized. A suitable material for the outer fabric layer is a nonwoven fabric such as DEXTER® 7844 Drape and Gown from Ahistrom Fiber Composites, Windsor Locks Plant, Two Elm Street, Windsor Locks, CT 06096-2335. The sheet layer may have any color desired by the end user. By custom and tradition, hospital beddings typically have a blue color. Therefore, the material used to form the sheet layer of bed pads used in hospital environments can have a blue color. However, bed pads used in a military setting, e.g. stretchers and/or bedrolls, may have a different color suitable for the location where they are used, e.g. tan for deserts, camouflage for jungles, etc.

In accordance with another aspect of the invention, the bed pad utilizes one or more outer layers, e.g. a top layer and/or a bottom layer, that is formed from Tyvek®. One or both of these Tyvek® outer layers can constitute the previously described sheet layer(s). Tyvek® is formed by a process using continuous and very fine fibers of 100% high-density polyethylene that are randomly distributed and nondirectional. These fibers are first flash spun, then laid as a web on a moving bed before being bonded together by heat and pressure—without the use of binders, sizers or fillers. By varying both the lay-down speed and the bonding conditions, technicians can engineer the flashspun sheet to meet market needs. Preferably, Tyvek® soft structure layers(s) are utilized. Tyvek® layers are generally described herein as layers exclusively comprising non-woven or randomly distributed very fine polyethylene fibers that are bonded to one another. Although it is preferred to utilize the described layers comprising 100% polyethylene fibers, it is contemplated that the bed pads could use outer layers having compositions using from about 90% to about 99% polyethylene fibers, and particularly from about 95% to about 98% polyethylene fibers. However, for most applications, it is preferred to use such layers that comprise 100% polyethylene fibers.

Tyvek® soft structure is designed specifically for those textile applications where drape, hand, and soft feel are of prime importance. Made from very fine, high density polyethylene fibers, Tyvek® brand protective material offers all the best characteristics of paper, film and fabric in one material. This unique balance of properties, which cannot be found in any other material, makes Tyvek® lightweight yet strong; vapor-permeable, yet water-, chemical-, puncture-, tear-, and abrasion-resistant. Tyvek® is also low-linting, smooth and opaque.

Generally, a wide array of Tyvek® layers or sheets may be used in the bed pads. Preferred Tyvek® or comparable materials exhibit basis weights of from about 1 to about 3 oz/yd², with particularly preferred basis weights of from about 1.10 to about 1.20 oz/yd², from about 1.20 to about 1.30 oz/yd², and depending upon the particular application, most preferred basis weights of about 1.15 oz/yd², 1.25 oz/yd², 2.9 oz/yd², 1.74 oz/yd², 2.8 oz/yd², and from about 1.8 oz/yd² and greater. Representative thickness values for the preferred Tyvek® layers or comparable layers range from about 5 to about 20 mils, with preferred thickness values, depending upon the particular application, of about 6.3, 6.6, 10.3, and 14 mils.

Examples of particularly preferred Tyvek® soft structure materials include Type 14 Tyvek®. Type 14 styles offer excellent wet and dry protection against particulate matter and provide an excellent barrier. High opacity and good surface stability. Tyvek® meets all the requirements of the USA Flammable Fabrics Act, CA-191-53, for wearing apparel.

It is contemplated that Type 16 Tyvek® could also be used. Type 16 Tyvek® is pin perforated with 10-15 mil (0.25 mm-0.38 mm) holes, giving it much higher air and moisture permeability, additional softness, and greater flexibility and drape than the above Type 14 style, at the expense of lower tear strength and barrier properties. Higher quality and more durable than standard nonwovens when used inside sofa and chair cushions.

Types 14 and 16 are “soft,” pointbonded products with an embossed pattern, providing a fabric-like flexible substrate with good printability and tear resistance. Type 14 styles are used where barrier and durability are required. Type 14 styles offer excellent wet and dry protection against particulate matter and provide an excellent bacterial barrier. 1422R & 1443R are acid free, lint free, tear resistant, water resistant, and breathable.

Type 16 styles are pin perforated with 10-15 mil (0.25-0.38 mm) holes, giving them much higher air and moisture permeability, additional softness, and greater flexibility and drape than Type 14 styles, but at the expense of lower tear strength and barrier properties. Type 16 styles are also available as acid and lint free.

TABLE 1
Tyvek ® Soft Structure
Technical Specifications

| | 1422R | | 1443R | | 1622E | | Test Method |
|---|---|---|---|---|---|---|---|
| Basis weight, | 1.15 | (Avg. 1.10-1.20) | 1.25 | (Avg. 1.20-1.30) | 1.15 | (Avg. 1.10-1.20) | ASTM D3776 |
| oz/yd² | | | | | | | |
| Strip tensile | 7.5 | (5.2-9.8) | 8.5 | (5.9-11.1) | 7.3 | (5.0-9.6) | ASTM D 1117 |
| (MD), lbs/in | | | | | | | |
| Strip tensile | 9.0 | (6.7-11.3) | 10.5 | (7.9-13.1) | 9.0 | (6.7-11.3) | ASTM D1117 |
| (XD), lbs/in | | | | | | | |
| Tongue tear | 2.4 | (1.4-3.4) | 2.7 | (1.7-3.7) | 1.8 | (1.0-2.6) | ASTM D2261 |
| (MD&XD), lbs. | | | | | | | |
| Air permeability, | N/A | | N/A | | 40 | (27-53) | ASTM D737 |
| Frazier ft³/ft-min. | | | | | | | |
| Electrical | 7.8 | (7.0-8.6) | 7.8 | (7.0-8.6) | 7.8 | (7.0-8.6) | AATCC 76 |
| resistivity, log R | | | | | | | |

Other Tyvek® grades are contemplated for use in the present invention bed pads, include but are not limited to UV soft structures that can include 1460 UV, Reflektra™, Supra™, Plus™, and combinations of these grades.

1460 UV 1.74 oz/yd² is used for applications that need protection from harmful ultra-violet sunlight. As with all Tyvek®, it keeps water out and allows trapped water to evaporate preventing mildew. 1460 keeps out acid rain, bird droppings, soot, debris, pollen, and other forms of environmental pollution. It filters out 98% of dust particles in the 2-micron diameter range. This grade is inert to acids and bases as well as other chemicals, 1460 is oleophilic and absorbs oils and greases with little penetration. In the sun, 1460 keeps the temperature of what it is covering lower than other products. This grade stores compactly when not in use. 1460 is the base substrate for styles Reflektra™, Supra™ and Plus™.

Reflektra™ UV 1.74 oz/yd² is vacuum metalized with aluminum. Reflektra™ offers superior heat protection—boasting a 40% greater capacity to reflect heat compared to styles 1460, Plus™ and Supra™. Brilliantly reflective and lightweight, Reflektra™ has all the qualities as the above style 1460. Reflektra™ is a high-performance outdoor cover. This grade stores compactly.

Supra™ UV 2.8 oz/yd² is a bi-laminate structure designed to provide exceptional protection. Supra™ is type 1460 with a skeletal reinforced scrim. Providing the same outstanding protection from the elements as the above two styles, Supra™ is heavier, less supple, and should be used where extra strength is necessary.

Plus™ UV 2.9 oz/yd² is a bi-laminate structure comprised of type 1460 laminated to a soft non-woven inner lining. This inner lining, made of flashspun high density polyethylene and polypropylene, offers excellent protection from the elements while providing a soft, somewhat cushiony inside surface for added protection.

TABLE 2
Tyvek ® UV Soft Structure
Technical Specifications
PLUS ™

| Strength | Test Method | Average Value |
|---|---|---|
| Tensile Strength | Grab Tensile (ASTM D1682) | 40/50 lbf. MD/CD |
| Bursting Strength | Mullen Burst (ASTM D774) | 90 psi |
| Tear Resistance | Trap Tear (ASTM D1117) | 9/8 lbf. MD/CD |
| Barrier | | |
| Filtration | Pore Size ASTM F-316 | 2-15 microns |
| Water Resistance | Hydrostatic Heat (AATCC 127) | >50 inches without penetration |
| Dimensional | | |
| Basis Weight | ASTM D-1777 | 2.9 oz/yd² |
| Thickness | TAPPI T-410 | 14 mils |
| Breathability | | |
| Water Vapor Transmission | (ASTM E-96 Method B) | >800 g/m² - 24 hrs. |
| Durability | | |
| UV | Natural Exposure @ 700 Mi/m² | Maintains approximately 50% |
| | (Appx. 2 years worst case exposure) | of Tensile Strength |
| Strength | Testing Method | Average Value |

1460

| | | |
|---|---|---|
| Tensile Strength | Grab Tensile (ASTM D1682) | 30/40 ibf. MD/CD |
| Bursting Strength | Mullen Burst (ASTM D774) | 85 psi |
| Tear Resistance | Trap Tear (ASTM D1117) | 9/6 ibf. MD/CD |
| Barrier | | |
| Filtration | Pore Size ASTM F-316 | 2-15 microns |
| Water Resistance | Hydrostatic Heat (AATCC 127) | >50 inches w/out penetration |
| Dimensional | | |
| Basis Weight | ASTM D-1777 | 1.74 oz/yd² |
| Thickness | TAPPI T-410 | >6.6 mils |
| Breathability | | |
| Water Vapor Transmission | (ASTM E-96 Method B) | >800 g/m² 24 hours |
| Durability | | |
| UV | Natural Exposure @ 700 Mi/m² | maintains approximately |
| | (2 years extreme worst case exposure) | 50% of Tensile Strength |

SUPRA ™

| | | |
|---|---|---|
| Tensile Strength | Grab Tensile (ASTM D1682) | 91/14 lbf. MD/CD |
| Elasticity | % Elongation to Break (ASTM D 882) | 14/17% MD/CD |
| Toughness | Work to Break (AST D882) | 17/22 in-lbf. |
| Bursting Strength | Mullen Burst (ASTM D774) | 137 psi. |
| Tear Resistance | Trap Tear (ASTM D117) | 22/14 lbf. MD/CD |
| Barrier | | |
| Filtration | Pore Size ASTM F-316 | 2-15 Microns |
| Water Resistance | Hydrostatic Heat (AATCC 127) | >50 inches w/out penetration |
| Water Vapor Transmission | ASTM E-96 Method B | 587 g/m² 24 hours |
| Dimensional | | |
| Basis Weight | ASTM D-1777 | 2.8 oz/yd² |
| Thickness | TAPPI T-410 | 10.3 mils |
| Water Vapor Transmission | (ASTM E-96 Method B) | >800 g/m² 24 hours |
| Durability | | |
| UV | Natural Exposure @ 840 Mi/m² | 37% Reduction in Tensile |
| | (3 years extreme worst case exposure) | |

REFLEKTRA ™

| | | |
|---|---|---|
| Tensile Strength | Grab Tensile (ASTM D1682) | 30/40 lbf. MD/CD |
| Bursting Strength | Mullen Burst (ASTM D774) | 75 psi |
| Tear Resistance | Trap Tear (ASTM D1117) | 7/5 lbf. MD/CD |
| Barrier | | |
| Filtration | Pore Size ASTM F-316 | 2-15 microns |
| Water Resistance | Hydrostatic Heat (AATCC 127) | >50 inches without penetration |
| Infrared Reflectivity | D&S Emissometer | >70% |
| Dimensional | | |
| Basis Weight | ASTM D-1777 | >1.8 oz/yd² |
| Thickness | TAPPI T-410 | >6.3 mils |
| Breathability | | |
| Water Vapor Transmission | (ASTM E-96 Method B) | >550 g/m² - 24 hrs. |
| Durability | | |
| UV | Natural Exposure @ 700 Mi/m² | Maintains 50% Tensile |
| | (2 years extreme worst case exposure) | Strength |

Tyvek® and its various grades are available ultimately through DuPont, and a wide array of distributors including Material Concepts of Philadelphia, Pa.

A preferred embodiment bed pad according to the present invention provides significant advantages, particularly in terms of strength and durability. Many Tyvek® layers, when incorporated in the bed pads, exhibit strengths of up to 800 pounds, yet only add approximately 2 pounds of additional weight to a 69″ by 60″ bed pad. The use of such Tyvek® layers for smaller bed pads is also contemplated, such as 36″ by 60″. The use of a Tyvek® bottom layer can also provide significant abrasion-resistance properties to the bed pad. For example, bed pads utilizing a Tyvek® bottom layer, loaded with 200 pounds, equivalent to an average patient weight, can, in emergency situations, be dragged across asphalt or concrete surfaces for extended distances without significant damage.

A series of comparative trials were conducted to investigate the strength and durability benefits provided by a Tyvek® bottom layer in a bed pad according to the present invention. A set of bed pads, as described herein, differing in only the use of a Tyvek® underside layer, were loaded with 180 pounds of weight (to simulate a patient) and then dragged across an asphalt parking lot. Each bed pad tested was dragged for a distance of 400 yards. Damage to the underside of each bed pad was assessed based upon the degree of tears, rips, or ruptures of the material along the underside of the pad. The bed pads utilizing the Tyvek® layer performed significantly better than the bed pads not utilizing Tyvek®. The bed pads without a Tyvek® underside layer exhibited approximately twice the amount and degree of damage as did the bed pads with a Tyvek® bottom layer.

The optional drapes, like the sheet layer, are a single-layer material made from a breathable material, preferably a fabric material. Although a single layer is preferred, a multi-layer material may be used. They may also possess water-repellant or water-absorbent properties and low-friction or high-friction properties. The drapes have a width of from about 12 inches to about 36 inches and a length of from about 24 inches to about 60 inches. In one embodiment, the drapes have a width of about 24 inches and a length of about 48 inches. An optional complementary fastening means may also be integrally attached to the drapes. These means include, but are not limited to, Velcro straps, button and buttonhole, clasp and slot, zippers, and other complementary fastening means known in the art. The drapes are preferably integrally attached to the sheet layer so that the length of the drapes is perpendicular to the length of the sheet layer. The drapes are placed along the length of the bed pad so that when a person is lying on the bed pad, they can be folded up around the person's arms to protect them during movement and to prevent them from impeding personnel around the bed pad.

A bed pad is formed by providing a padding layer and a sheet layer and attaching the sheet layer to the padding layer. The sheet layer is attached to the padding layer by any suitable means known in the art. A preferred technique for attaching the sheet layer to the padding layer is by laminating the sheet layer to the padding layer using an adhesive such as a powdered adhesive or a sheet adhesive. If desirable, the attachment of the sheet layer to the padding layer may be reinforced by further stitching portions of the sheet layer to the padding layer. To reinforce the attachment of the sheet layer to the padding layer, such as by stitching, any portion of the sheet layer may be stitched to the padding layer. For example, the sheet layer may be stitched around the interior of the sheet layer (i.e., along each side at a given distance from the end of the sheet/pad), or the sheet may be stitched to the padding layer along one or multiple locations of either the length and/or width of the pad. The sheet layer may have the same dimensions as the padding layer, such that when the sheet layer is attached to the padding layer the peripheral edges of the padding layer are exposed. Optionally, the sheet layer may have dimensions such that the sheet layer has a length and/or width greater than the length and/or width of the padding layer. In such configurations, the ends of the sheet layer are pulled over the edges of the padding layer and attached to the underside of the padding layer (by any suitable means including, but not limited to, sewing, stitching or laminating) so that the sheet layer essentially forms a seal around the edges of the padding layer. Such a configuration may be desirable to prevent contamination of the padding layer should it come in contact with fluids that escape from the sheet layer. Encompassing the padding layer's edges with portions of the sheet layer is not necessary, however, if the padding layer includes or is treated with an antibacterial agent or material. The length and/or width of the sheet layer are never smaller than the length and/or width of the padding layer.

When utilizing one or more layers formed from Tyvek®, and in particular soft structure Tyvek®, the following guidelines are useful during manufacturing of the preferred embodiment bed pads.

Tyvek® can be sewn satisfactorily on any conventional sewing machine. Best results are obtained from machines equipped with puller or drop feed. Smooth, rubber-covered rolls should be used rather than knurled metal rolls which tend to leave impressions on the material. When stitching Tyvek®, use the least number of stitches per inch and the smallest needle practical for maximum resistance to tearing. Both lock stitches and chain stitches work well, especially at 1″ (2.5 cm) chain stitch which can prevent raveling. Tyvek® can be sewn on any conventional sewing machine.

Sewing Tyvek® Type 14 and 16 (Including Styles Reflektra™ and Supra™)

Up to 12 stitches/in. (4.7 stitches/cm) can be used; however, 6-8 stitches/in. (2.4-3.1 stitches/cm) provide the highest seam strength (greatest resistance to postage stamp tear).

Use a fine-tooth feed dog—12 to 21 teeth/in. (4.7-8.3 teeth/cm).

Decrease presser-foot tension until the sheet just feeds through the machine without slipping. About 10 lb. (4.5 kg) force should be sufficient.

Decrease bobbin tension until the bobbin just slips down the thread; 3 oz. (85 g).

Wind bobbin with thread tension set so that the thread just slips through the disc; 2 oz. (57 g).

After setting bobbin tension, adjust needle tension to produce a balanced stitch.

Conventional threads of cotton/synthetic or 100% polyester may be used.

Spun-filament polyester is stronger than cotton thread and is preferred for flame-resistant considerations.

Gluing Tyvek®

A number of adhesives can be used to glue Tyvek® either to itself or to other substrates. In general, water-based adhesives that provide quick tack and fast drying are preferred. However, the first step in choosing an adhesive is to determine how it will react with Tyvek®. Testing a small Tyvek® sample is the best way to make this determination.

Natural-product adhesives based on starch, dextrin, casein or animal byproducts are preferred to synthetic-based adhesives. Hot animal glue is an excellent adhesive for adhering Tyvek® to paperboard.

Water-based synthetic lattices also bond Tyvek® to itself and a variety of substrates. Ethylene/vinyl acetate adhesives are especially useful, as are the acrylic pressure-sensitive adhesives. Synthetic adhesives often contain low-molecular-weight materials that can act as solvents at elevated temperatures causing swelling and wrinkling. Solvent-based single-component polyurethane adhesives provide optimum adhesion (lap and shear), flexibility and water-resistance for adhering Tyvek® to itself, as well as a variety of substrates.

Heat Sealing Tyvek®

While it is possible to fuse Tyvek® to itself using only heat, strong seals are difficult to obtain in this way because melting the material destroys its fiber structure, reducing both flexibility and tear strength in the seal area. Non-corona-treated, non-antistated styles of Tyvek® are preferred for heat sealing Tyvek® to itself. The molecular film of oxide and antistat on the surface of corona treated/antistated Tyvek® causes a discontinuous melt to form, thus reducing the seal strength.

Trim seal dies, designed with a spring-loaded restraining plate, have been used successfully for heat sealing. However, the preferred method is to apply a coating with a melting point below that of Tyvek®, such as branched polyethylene. With such a coating, high seal strengths can be achieved using hot-bar or impulse techniques.

Tyvek®, like polyethylene film, cannot be dielectrically sealed by conventional methods. However, commercial proprietary processes have been developed that allow Tyvek® to be dielectrically sealed using conventional radio-frequency equipment. Recent developments in ultrasonic sealing have also demonstrated fiber tearing seals with most styles of Tyvek®, without the puckering that is often associated with heat seals of Tyvek®. This process also forms strong seals to a variety of plastic films and nonwovens.

The properties of the padding layer and sheet layer or layers may be combined to provide options suiting the end user's needs. In one embodiment, the bed pad is a three-layer composition where the padding layer and one of the sheet layers are water-absorbent and the other sheet layer is water-repellant. In another embodiment, the bed pad is a three-layer composition where one of the sheet layers is high-friction and the other sheet layer is low-friction. Such options would be beneficial by allowing the bed pad to be used in multiple situations, yet requiring the end user to stock only one type of bed pad.

When the optional strength-promoting layer is included, it is placed between the padding layer and a sheet layer and attached to both layers by any suitable means known in the art. It preferably has the same dimensions as the sheet layer so that in embodiments where the dimensions of the padding layer and sheet layer are different, strength is promoted across the larger sheet layer.

Where a bed pad includes handles or gripping means, the handles or gripping means may be attached or formed at any appropriate time. Handles, such as for example strap handles, are preferably attached to the bed pad after the sheet layer has been attached to the padding layer. Strap handles may be attached to the pad by attaching the ends of the strap to the pad by any suitable means such as sewing, stitching, stapling, bolting, or the like. A portion of the material used for the strap remains separated, i.e., unattached, from the bed pad. The unattached portion creates the handle and allows a user to take hold of the strap. In the case of preformed handles made from a solid, rigid material, such as plastic or metal, the handles are attached to the bed pad by any suitable means, including but not limited to bolting, screwing, clamping and the like. Removable retention straps are attached to the pad by a clip. The clip may secure the strap to the pad by forming a tight connection over the top of an end of the strap and the underside of the padding layer. Alternatively, the clip may extend through an opening on the strap and through an opening extending through both the sheet layer and the padding layer. The use of a clip allows a handle to be attached to the bed pad when needed to move the person. Removable handles also allow the handles to be removed when they are not needed, such that the handles do not provide an obstruction to the person while lying on the pad. Where the gripping means are holes or openings in the pad, such as slots cut along the periphery of the bed pad, the gripping means may be formed at any time during the formation of the bed pad. For example, holes or openings may be formed in the padding layer by cutting and removing a portion of the padding layer to form the holes or openings having a desired shape. Holes or openings may then be formed on the sheet layer corresponding in location, shape and size to the openings in the padding layer. The openings may be formed in the sheet layer either before or after the sheet layer is attached to the padding layer. Alternatively, openings may be formed in a bed pad after the sheet layer has been attached to the padding layer. In the case of a bed pad having openings to provide a means to grip or hold the bed pad, the periphery of the openings may further be stitched to reinforce the attachment of the sheet layer to the padding layer and to prevent the sheet layer from fraying or pulling away from the padding layer at those locations. While the holes, openings, handles, or other gripping means may be located anywhere on the bed pad, they are preferably located where they will not contact the person lying on the bed pad in order to prevent resulting pressure differences from causing bedsores or other problems. The gripping means may also be used as fastening means. In one embodiment where the bed pad is used as a bedroll, two spandex straps can be attached at one end of the pad near each side. When the pad is rolled up, the two spandex straps can go over the ends and keep the pad tightly rolled up for convenience.

When hinges are desired, they may be formed at any time during the formation of the bed pad. For example, tabs may be formed in the padding layer by cutting and removing a portion of the padding layer to form the tabs having a desired shape. Tabs may then be formed on the sheet layer corresponding in location, shape and size to the tabs in the padding layer. The padding layer and sheet layer are then joined together as described above. Alternatively, tabs may be formed in a bed pad after the sheet layer has been attached to the padding layer. The end of each tab is then heat sealed or heat bonded to the main body of the bed pad to form a hinge. This has the advantage of producing no exposed edges, preventing fraying.

The bed pad according to the present invention may serve as a supplemental layer of padding on the bed. The bed pad is placed on top of the mattress of a bed and provides another thin, soft layer for the person to lie on. The person is then placed on top of the bed pad according to the invention. More layers of padding may also be placed between the bed pad and the person if desired, though such layers should be smaller than the bed pad and not contain means to attach them directly to the mattress which would prevent the bed pad from fulfilling its function of providing for easy movement and/or transfer. The bed pad typically rests on top of the mattress or table. A bed pad may also include a means to further secure the bed pad to a mattress or table. For example, a bed pad may include an elastic band attached to and extending from either the sheet layer or the padding layer. Preferably an elastic band would be attached to the sheet layer. The band preferably extends around the periphery of the bed pad. An elastic band should have a sufficient width such that the band is capable of being pulled or stretched over the periphery of the mattress or table to form a tight connection between the bed pad and the mattress or table. Alternatively, a bed pad may include a material layer extending from and around the periphery of the sheet layer. The bottom of the material layer, i.e., the portion of the material layer that is furthest away from the sheet layer, preferably includes a strip of an elastic material similar to that found in traditional bed sheets. The material layer may be pulled over the mattress or table in a manner similar to traditional bed sheets. The use of such means allows a bed pad to be secured to a mattress or table to reduce the risk that the pad may slip or slide off the bed or table.

In a hospital setting, the bed pad also provides a means of adjusting a patient within the bed or for moving a person from one bed to another bed or table. Specifically, the pad is thin enough that it is easily manipulated and handled by medical personnel, but strong enough such that the entire pad may support the patient and allow for the patient to be moved by moving the pad without having to make physical contact with the person. To change the position of the patient within the bed, medical personnel may grab hold of the pad and slide the pad in the direction necessary to move the person. With respect to transferring a patient from one bed to another, personnel may grab hold of the pad and either physically lift the pad from the first bed and place it on the second bed, or slide the pad off of the first bed and onto the second bed. As previously described herein, the pad may also contain gripping means to grasp or take hold of the pad, including slots, handles, or the like. Upon grasping the pad via the gripping means, personnel may then lift and/or slide the bed pad to either change the patient's position and/or move the patient from one bed to another.

Another advantage of the bed pad embodiment utilizing lateral drapes is that in a hospital environment, once the pad is positioned on an operating table and a patient is on the pad, the drapes may be folded over or about the patient to secure the patient, and particularly, to secure the patient's arms for administration of an IV line. It is further contemplated that the bed pad could be incorporated into the upper layer of an operating table or examination table. The provision of one or more foldable drapes is believed to be of significant benefit.

The use of the bed pad according to the present invention makes patient movement more convenient and less arduous for medical personnel. It may require fewer personnel to move the patient compared to moving the patient by physically lifting, i.e., handling, the patient's body. Further, because the patient is lying on a uniform surface, the patient's limbs and extremities are not subjected to the jostling and random motion encountered in physically handling the patient. The bed pad according to the invention also has the advantage of being flexible and capable of conforming to the patient's body as compared to hard boards that are sometimes used to move a patient. The flexibility of the bed pad provides additional comfort and allows the patient to lie in a more natural position compared to a hard board.

A bed pad in accordance with the present invention may be used either in place of or in conjunction with traditional hospital beddings. First, a bed pad may be placed on a mattress as is commonly found in hospitals, nursing homes, or other patient care facilities. Such mattresses are typically capable of being adjustable so as to allow a portion of the patient's body to be positioned in an inclined and/or declined position. The thickness of the bed pad imparts flexibility to the bed pad such that the bed pad is capable of conforming to the position of the mattress. Further, the sheet layer allows a bed pad to be used in place of traditional beddings. As previously described herein, the sheet layer is comprised of a fabric material. The fabric material provides a soft surface, comparable to traditional beddings, upon which the person lies. Thus the sheet layer of the bed pad serves the same role as that of a traditional bed sheet.

The combination of certain properties of the bed pad also renders it superior to traditional beddings. The low friction of the bed pad makes it easier to transfer patients by sliding them compared to traditional bedding. Fluid-repellant properties may make the bed pad more hygienic by preventing absorption of scents and liquids into the sheet layer and the padding layer of the bed pad. Such a bed pad may also be easier to clean because it would only need to be wiped down, washed off, and sterilized; it would not need to be changed. The absorbent properties of traditional beddings may make cleaning traditional bed sheets more difficult or impossible. It may take repeated attempts in between uses of traditional beddings to completely clean the bedding, or it may not be possible to sufficiently clean the bedding for reuse. Consequently, great expense may be involved in either cleaning and/or replacing traditional hospital beddings. Thus, a bed pad according to this development, which is easily cleaned and reused, may provide significant reductions in costs associated with cleaning and/or replacing traditional beddings. Reducing the frequency with which the bedding must be changed and/or replaced also reduces the number of times that a patient needs to be moved. A bed pad is disposable and easily replaced if necessary. Preferably, a bed pad will be used only once before it is discarded. However, the ability to be reused may be desirable for at-home patient care or where it is financially desirable to reuse the pads.

The bed pad according to the present invention also finds use in a military environment. When the bad pad has straps or hinges, it may be used as part of a stretcher. It can also be used as a bedroll for military personnel, recreational users, etc.

When the bed pad includes drapes, the drapes can be used to secure the person's arms within the dimensions of the bed pad itself.

It will be understood that any of the features of the various embodiments may be combined or used in conjunction with any of the other features of other embodiments described herein.

The development has been described with reference to the preferred embodiments. Still, other modifications and alterations will occur to others upon a reading and understanding of this specification. The specification is intended to include all such modifications and alterations to the extent they come within the general concept hereinabove described.

What is claimed is:

1. A bed pad comprising:
a padding layer having an upper surface and a lower surface;
a strength-promoting layer; and
at least a first sheet layer disposed adjacent to the upper surface of the padding layer,
wherein said first sheet layer consists essentially of randomly distributed, very fine polyethylene fibers that are bonded to one another.

2. The bed pad of claim 1 wherein the first sheet layer includes 100% polyethylene fibers.

3. The bed pad of claim 1 wherein the polyethylene fibers are high density polyethylene fibers.

4. The bed pad of claim 1 wherein the first sheet layer has a basis weight of from about 1 to about 3 oz/yd².

5. The bed pad of claim 1 wherein the first sheet layer has a thickness of from about 5 to about 20 mils.

6. The bed pad of claim 1, wherein said bed pad comprises a plurality of gripping components selected from the group consisting of (i) reinforced openings in the bed pad, (ii) handles, (iii) straps, and combinations thereof.

7. The bed pad of claim 1, wherein said first sheet layer comprises a border extending along at least a majority of one side of the bed pad, said border having a height of about 0.25 inches and a width of from about 0.5 inches to about 1.5 inches.

8. The bed pad of claim 1, wherein said padding layer comprises an antibacterial component.

9. The bed pad of claim 1, wherein said padding layer and said at least first sheet layer are attached together by stitching, laminating, sewing, stapling, thermal bonding, or combinations thereof.

10. The bed pad of claim 1, further comprising a second sheet layer.

11. The bed pad of claim 10 wherein the strength-promoting layer and the padding layer are disposed between the first and second sheet layers.

12. The bed pad of claim 1 further comprising:
at least one drape extending from the bed pad.

13. The bed pad of claim 1 further comprising:
two laterally extending drapes, attached to the bed pad, and adapted to at least partially wrap about a person disposed on the bed pad.

14. The bed pad of claim 13 wherein the drapes are releasably attached to the bed pad.

15. The bed pad of claim 13 wherein the drapes are permanently attached to the bed pad.

16. The bed pad of claim 1 further comprising at least one outwardly projecting tab along an edge of the bed pad.

17. The bed pad of claim 16 wherein the tab defines an aperture adapted to receive a support member.

18. A bed pad comprising:
a first sheet layer;
a second sheet layer;
a padding layer disposed between said first sheet layer and said second sheet layer; and
a strength-promoting layer disposed adjacent to the padding layer;
wherein said first and second sheet layers each include a web of heat and pressure bonded, 100% polyethylene fibers, said bed pad including a plurality of gripping components selected from the group consisting of (i) reinforced openings defined in the bed pad, (ii) handles, (iii) straps, and combinations thereof.

19. The bed pad of claim 18 wherein the polyethylene fibers of each of the first and the second sheet layers are randomly distributed and nondirectional.

20. The bed pad of claim 18 wherein the polyethylene fibers are high density polyethylene fibers.

21. The bed pad of claim 18 wherein each of the first sheet layer and the second sheet layer has a basis weight of from about 1 to about 3 oz/yd².

22. The bed pad of claim 18 wherein each of the first sheet layer and the second sheet layer has a thickness of from about 5 to about 20 mils.

23. The bed pad of claim 18, wherein said first sheet layer comprises a border extending along at least a majority of one side of the bed pad, said border having a height of about 0.25 inches and a width of from about 0.5 inches to about 1.5 inches.

24. The bed pad of claim 18 further comprising a sensing system adapted to sense the presence or absence of liquids disposed on the bed pad.

25. The bed pad of claim 18 further comprising a sensing system adapted to sense the application of a force or pressure on the bed pad.

26. The bed pad of claim 18 further comprising at least one tab.

27. A bed pad comprising:
a first sheet layer;
a second sheet layer;
a strength-promoting layer disposed between said first sheet layer and said second sheet layer; and
a padding layer disposed between said first sheet layer and said second sheet layer;
wherein said first and second sheet layers each exclusively comprise randomly distributed very fine high density polyethylene fibers that are bonded to one another, each of the first and second sheet layers having a basis weight of from about 1 to about 3 oz/yd², said bed pad including a plurality of gripping components.

28. The bed pad of claim 27, wherein said first sheet layer comprises a border extending along at least a majority of one side of the bed pad, said border having a height of about 0.25 inches and a width of from about 0.5 inches to about 1.5 inches.

29. The bed pad of claim 27 further comprising:
at least one drape extending from the bed pad.

30. The bed pad of claim 27 further comprising:
two laterally extending drapes, attached to the bed pad, and adapted to at least partially wrap about a person disposed on the bed pad.

31. The bed pad of claim 27 further comprising at least one hinge.
